(19) United States
(12) Patent Application Publication
(10) Pub. No.: US 2025/0068412 A1
(43) Pub. Date: Feb. 27, 2025

(54) SYSTEM AND METHOD FOR UPDATING A SOFTWARE APPLICATION IN A MULTI-TENANT CLOUD NETWORK

(71) Applicant: Alkira, Inc, San Jose, CA (US)

(72) Inventors: Santosh Kumar Dornal, San Ramon, CA (US); Sudarvannan Sivakumar, Milpitas, CA (US); Sanchit Lodha, San Jose, CA (US); Veera Raghavendra Prasad Ravinutala, San Ramon, CA (US); Bharath Chakravarthy, San Ramon, CA (US)

(21) Appl. No.: 18/809,337

(22) Filed: Aug. 20, 2024

Related U.S. Application Data
(60) Provisional application No. 63/578,965, filed on Aug. 25, 2023.

(51) Int. Cl. G06F 8/65

(52) U.S. Cl. CPC G06F 8/65

(57) ABSTRACT

Provided are a system and a method for updating a software application in a multitenant cloud network. The system may receive a request to execute an update of the software application on a tenant node associated with the multi-tenant cloud network. Responsive to receiving the request, the system may cause to install the updated version on the tenant node. The updated version relates to a micro-service of the software application. Further, the system may obtain operational parameters relating to the tenant node, and provision the updated version on the tenant node while the tenant node is executing instances of the software application during the provisioning of the updated version based on the operational parameters and the high availability architecture. The operational parameters comprise at least operation timing and operational traffic data.

### TECHNOLOGICAL FIELD

The present invention generally relates to multi-tenant cloud network providing software-as-a-service. More particularly, the present disclosure relates to updating a software application in a multi-tenant network.

### BACKGROUND

Software-as-a-service (SaaS) refers to a software application delivery model where a software vendor develops a web-native software application and hosts and operates the software application for use by its customers over the Internet. SaaS applications are an increasingly popular model for providing software functionality as it is economical in terms of both cost and customer hardware resources. The Software-as-a-service architecture may run on a cloud infrastructure for serving multiple tenants or customers. These SaaS services are also referred to as cloud services. These cloud services may relate to applications such as email, financial systems, accounting, bookkeeping and others.

The software application needs to be continuously updated. An update is new, improved, or fixed software application that replaces older versions of the same software application on computing nodes. For example, updating the software application brings the software application up-to-date with the latest functionalities, features, patches, etc.

### BRIEF SUMMARY OF SOME EXAMPLE EMBODIMENTS

A system and a method are provided herein for updating a software application in a multi-tenant cloud network to provide an updated and reliable version of software application to tenants.

In one aspect, a system for updating a software application in a multi-tenant cloud network is disclosed. The system comprises a memory configured to store computer executable instructions; and one or more processors configured to execute the instructions to receive a request to execute an update of the software application on a tenant node associated with the multi-tenant cloud network, wherein the update is for a conversion of the software application from a current version to an updated version. The processor is further configured to cause to install the updated version on the tenant node responsive to receiving the request. The updated version relates to a micro-service of the software application. The processor is further configured to obtain operational parameters relating to the tenant node, the operational parameters comprising at least operation timing and operational traffic data. Further, based on the operational parameters and a high availability architecture relating to the software application, the processor is further configured to provision the updated version of the software application on the tenant node while the tenant node is executing instances of the software application during the provisioning of the updated version.

In additional system embodiments, wherein the multi-tenant cloud network associated with the software application comprises a plurality of data cluster nodes configured to carry user traffic data associated with the tenant node across different connecting endpoints of a tenant architecture associated with the tenant node. The multi-tenant cloud network associated with the software application further comprises one or more control cluster nodes configured to provision a set of rules for the plurality of data cluster nodes based on a corresponding region. Further, the multi-tenant cloud network further comprises a management node configured to enable management of at least one of: the tenant node, network configuration, infrastructure resource, and software application inventory.

In additional system embodiments, the processor is further configured to cause the tenant node to access the software application associated with the multi-tenant cloud network using the management node.

In additional system embodiments, the processor is further configured to deploy a continuous integration and continuous deployment pipeline to enable automated identification of a problem associated with the micro-service of the software application. Further, the processor is further configured to cause the multi-tenant cloud network to generate the updated version of the software application. The updated version is configured to address the identified problem

In additional system embodiments, wherein the updated version of the software application comprises at least one of: one or more new feature functionalities, or bug fix over the current version.

In additional system embodiments, wherein the instances of the software application executing on the tenant node relates to micro-services other than the micro-service of the updated version.

In another aspect, a method for updating a software application in a multi-tenant cloud network is disclosed. The method comprises receiving a request to execute an update of the software application on a tenant node associated with the multi-tenant cloud network. The update is for a conversion of the software application from a current version to an updated version. The method further comprises responsive to receiving the request, causing to install the updated version on the tenant node. The updated version relates to a micro-service of the software application. The method further comprises obtaining operational parameters relating to the tenant node. The operational parameters comprise at least operation timing and operational traffic data. Further, the method comprises provisioning the updated version of the software application on the tenant node while the tenant node is executing instances of the software application during the provisioning of the updated version based on the operational parameters and a high availability architecture relating to the software application.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a diagram of an example of a system for multi-tenant orchestration, in accordance with an example embodiment;

FIG. 2 is a diagram of an example of a cloud exchange point (CXP), in accordance with an example embodiment;

FIG. 3 is a diagram of an example of a horizontally scalable multi-tenant service bounding, in accordance with an example embodiment;

FIG. 4 illustrates an example block diagram for multi-tenant cloud network, according to an example embodiment;

FIG. 5 is a diagram of an example computer system, in accordance with an example embodiment;

FIG. 6 is a diagram of an example of a tenant node configuration system, in accordance with an example embodiment;

FIG. 7 shows a network environment in which a system for updating a software application in a multi-tenant cloud network is implemented, according to an example embodiment;

FIG. 8 shows a block diagram of the system for updating the software application in the multi-tenant cloud network, according to an example embodiment;

FIG. 9 illustrates an example flowchart of a method for updating the software application on a tenant node, according to an example embodiment; and

FIG. 10 illustrates an example flowchart of a method for updating the software application in the multi-tenant cloud network, according to an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Embodiments of the present disclosure provide a system and a method for updating a software application on a tenant node in a multi-tenant cloud network. Typically, updating of a software application, specifically, a software application provided by a SaaS service provider may be is a lengthy and tiresome process, and may require a technical professional. During updating of the software application, a computing node may have to be shut down, or operation of the software application may be interrupted. This is highly undesirable, especially, in cases where day-to-day work of people in an organization is dependent on such software application.

For example, restarting the computing node may make the software application and the computing node unavailable for a user of the computing node. This unavailability may result in downtime of the computing node, which can be frustrating and disruptive, especially if the user relies on the software application for work or other important task. In certain cases, the restart may also lead to data loss in the downtime. The restart of software application may also put user data at security risk. For example, if the software application is not restarted successfully after receiving a security update, it may still be vulnerable to the security flaw that the update was designed to fix. This may put the user's data and personal information at risk. There might be some performance issues generated due to failed restart of the software application. For example, if the software application is not restarted successfully after receiving the update, it may create problems which may affect its usability or reliability. Therefore, the software applications may need to be updated on computing nodes or tenant nodes in a more efficient manner.

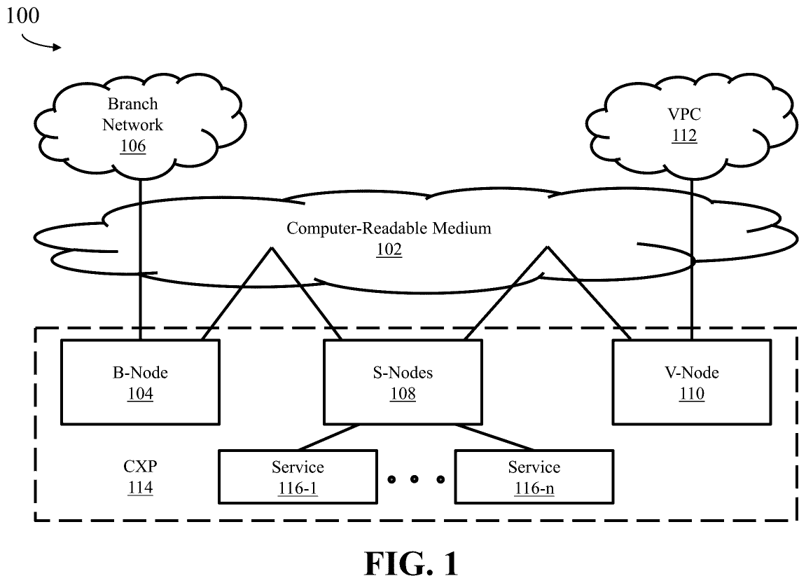

FIG. 1 is a diagram 100 of an example of a system for multi-tenant orchestration, in accordance with an embodiment. The diagram 100 includes a computer-readable medium (CRM) 102, a branch-facing node (B-node) 104 coupled to the CRM 102, a branch network 106 coupled to the B-node 104 through the CRM 102, service point attachment nodes (S-nodes) 108 coupled to the CRM 102, a virtual network facing node (V-Node) 110 coupled to the CRM 102, and a virtual private cloud (VPC) 112 coupled to the V-Node 110 through the CRM 102. In the diagram 100, a cloud services exchange platform (CXP) 114 includes the B-node 104, the S-nodes 108, the V-node 110, and a service engine 116-1 to a service engine 116-n (collectively, the services 116) coupled to the S-nodes 108.

The CRM 102 in intended to represent a computer system or network of computer systems. A “computer system,” as used herein, may include or be implemented as a specific purpose computer system for carrying out the functionalities described in the present disclosure. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software application, some of this data is often written, by a direct memory access process, into memory by way of a bus coupled to non-volatile storage. Non-volatile storage can be local, remote, or distributed, but is optional because systems can be created with all applicable data available in memory.

Software application in a computer system is typically stored in non-volatile storage. Indeed, for large programs, it may not even be possible to store the entire program in memory. For software application to run, if necessary, it is moved to a computer-readable location appropriate for processing, for example, that location is referred to as memory. Even when software application is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example operation, a computer system can be controlled by operating system software, which is a software program that includes a file management system, such as a disk operating system. The file management system is typically stored in the non-volatile storage and causes the processor to execute the various acts required by the operating system to input and output data and to store data in the memory, including storing files on the non-volatile storage.

The bus of a computer system may couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g. “direct PC”), or other network interface for coupling a first computer system to a second computer system. An interface can be considered part of a device or computer system.

Computer systems may be compatible with or implemented as part of or through a cloud-based computing system. As used in the present disclosure, a cloud-based computing system is a system that provides virtualized computing resources, software and/or information to client devices. The computing resources, software and/or information may be virtualized by maintaining centralized services and resources that the edge devices can access over a communication interface, such as a network. The cloud-based computing system may involve a subscription for services or use a utility pricing model. Users can access the protocols of the cloud-based computing system through a web browser or other container application located on their client device.

The term “cloud computing” refers to use of hosted services, such as data storage, servers, databases, networking, and software over the internet. The data may be stored on physical servers that may be maintained by a cloud service provider. Computer system resources, such as the data storage and computing power, may be available on-demand, without direct management by a user in a cloud computing environment. Cloud computing may be utilized to remotely store and access data and programming that utilizes the internet rather than hosting information on a hard drive of a system.

Further, cloud may be divided into two different layers, such as a front-end and a back-end. The front-end may be configured to interact with the users in the cloud computing environment. This front-end enables the user to access the data stored in the cloud through cloud computing software. Moreover, the back-end may be configured to primarily store the data or information securely. The back-end may include one or more software and hardware such as the computers, servers, central servers, and databases.

A computer system may be implemented as an engine, as part of an engine, or through multiple engines. In an example, an engine includes at least two components: 1) a dedicated or shared processor or a portion thereof; 2) hardware, firmware, and/or software modules executed by the processor. A portion of one or more processors may include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine may have one or more dedicated processors, or a first engine and a second engine can share one or more processors with one another or other engines. Depending upon implementation-specific or other considerations, an engine can be centralized, or its functionality distributed. An engine may include hardware, firmware, or software embodied in a computer-readable medium for execution by the processor. The processor transforms data into new data using implemented data structures and methods, as described with reference to various embodiments of the present disclosure.

The engines, or the engines through which the systems and devices described in the present disclosure may be implemented, may be cloud-based engines. For example, a cloud-based engine is an engine that can may applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

Further, data stores are intended to include repositories having any applicable organization of data, including tables, comma-separated values (CSV) files, traditional databases (e.g., SQL), or other applicable known or convenient organizational formats. Data stores can be implemented, for example, as software embodied in a physical computer-readable medium on a general- or specific-purpose machine, in firmware, in hardware, in a combination thereof, or in an applicable known or convenient device or system. Data store-associated components, such as database interfaces, can be considered “part of” a data store, part of some other system component, or a combination thereof, though the physical location and other characteristics of data store-associated components is not critical for an understanding of the techniques described in the present disclosure.

Data stores may include data structures. In an example, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The data stores may be cloud-based data stores. A cloud-based data store is a data store that is compatible with cloud-based computing systems and engines.

Assuming a CRM includes a network, the network can be an applicable communications network, such as the Internet or an infrastructure network. The term “Internet” refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The B-Node 104 is intended to represent an engine that couples the branch network 106 to the CXP 114. In a specific implementation, the B-node is responsible for branch-to-cloud traffic. For example, the branch network 106 is intended to represent a campus, site, data center, or other branch network under the control of a customer. In a specific implementation, the B-node 104 creates an overlay to connect a network branch to the cloud. Data traffic originating from the branch network 106 within a given region may be controlled, managed, observed, and evaluated by the CXP 114. In a specific implementation, the customer, or a human or artificial agent thereof, managing the branch network 106, or a portion thereof, can access a single portal to select one or more of the services 116 in connection with a software as a service (SaaS), infrastructure as a service (IaaS), or platform as a service (PaaS) offering. In a specific implementation, the B-node 104 (potentially including other B-nodes, not shown) connects the CXP 114 to multiple different branch networks.

The S-nodes 108 are intended to represent multi-tenant node engines adapted to orchestrate the instantiation, hosting, and/or provisioning of the services 116 (selected via a portal accessible in association with the CXP 114) to one or more endpoints on behalf of a customer. S-nodes 108 may host services and apply policies that might otherwise only be available through other cloud platforms, in other regions or otherwise only available with certain connectivity. For instance, if a customer using Cloud Platform A desired certain security features provided by Firewall X service that was only available through Cloud Platform B, the S-nodes 108 may, via an orchestration component, host the Firewall X service for the customer so that the customer may obtain the service as though they were using Cloud Platform B. Even if a customer uses different cloud platforms or has different connectivity throughout different segments of its network, the dashboard of the CXP 114's portal may provide the foregoing features (e.g., monitoring traffic, managing connectivity, etc.) within the same dashboard interface. In a specific implementation, to effectuate these features, all data traffic is routed through the S-nodes 108.

The S-nodes 108 may send/receive traffic to and from networks implementing any type of connectivity (e.g., MPLS, SD-WAN, IPsec, etc.) and host services from any one or more providers so that the connecting networks may receive the benefit of those services without the hassle of reconfiguring their network to adapt to the service provider's requirements. The S-nodes 108 can instantiate such services automatically upon request, so that an individual user associated with or connected through the branch network 106 does not have to instantiate the services themselves. The S-nodes 108 may collect telemetry data (e.g., to share with a multi-tenant orchestrator component), may tie the data flow to an application once packet details have been determined, may conduct analytics (e.g., statistical analysis) on data flow on a tailored basis (e.g., one in every ten packets received may be subjected to a deep packet inspection routine), and may tag or add instructions to packets for execution at a workload.

The V-Node 110 is intended to represent an engine that couples the CXP 114 to the VPC 112. The VPC 112 is intended to represent a SaaS, IaaS, PaaS, or V-net. In a specific implementation, the V-node is responsible for cloud-to-cloud traffic. For example, the V-node 110 (potentially including other V-nodes, not shown) connects the CXP 114 to different clouds.

The CXP 114 is intended to represent a system that establishes connectivity, instantiates services for corresponding geo-locations, aggregates data, implements policies, monitors traffic, and/or provide analytics across disparate cloud service providers and different connectivity architectures. In a specific implementation, CXP 114 operates in a manner that—to the customer—is connectivity agnostic and cloud provider agnostic. The CXP 114 may correspond to aggregated services offered for a given region or set of regions, where the regions may comprise one or more zones corresponding to subsections of such regions. The CXP 114 may service the branch network 106 within a particular region, and multiple CXPs may be stitched together as part of a larger cloud servicing network (e.g., mesh network, hub-and-spoke network, or a network having some other topology) to span multiple regions. In a specific implementation, the CXP 114 provides a portal through which a network administrator or other user associated with a customer may (i) view and select SaaS/IaaS/other services from a range of providers (or provided by the customer itself) within a common dashboard, (ii) manage connectivity (e.g., MLPS, SD-WAN, IPsec, etc.), (iii) monitor traffic, (iv) control traffic in accordance with one or more policies (e.g., security policies), etc.

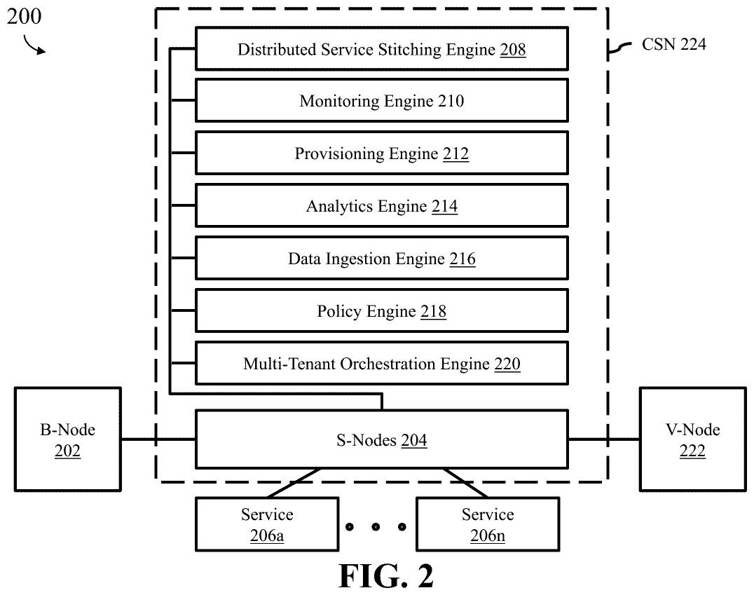

FIG. 2 illustrates a block diagram of an example cloud exchange point (CXP) 200. The CXP 200 includes a B-node 202, an S-nodes 204 coupled to the B-node 202, a plurality of service engines depicted as service engines 206A-206N (collectively referred to as services 206) coupled to the S-nodes 204, and a V-node 222.

The CXP 200 refers to a system that establishes connectivity, instantiates services for corresponding geo-locations, aggregates data, implements policies, monitors traffic, and/or provides analytics across disparate cloud service providers (CSP) and different connectivity architectures. In an example, the CXP 200 operates in a connectivity agnostic and cloud provider agnostic manner for a customer of the CXP 200. The CXP 200 may correspond to aggregated services offered for a given region or a set of regions, where the regions may comprise one or more zones corresponding to sub-sections of such regions. The CXP 200 may service the branch network or the segment 106 within a particular region, and multiple CXPs may be stitched together as part of a larger cloud servicing network (e.g., mesh network, hub-and-spoke network, or a network having some other topology) to span multiple regions. For example, the CXP 200 provides a portal through which a network administrator or other user associated with a customer may, for example, view and select SaaS/IaaS/other services from a range of service providers (or provided by the customer itself) within a common dashboard, manage connectivity (e.g., MLPS, SD-WAN, IPsec, etc.), monitor traffic, control traffic in accordance with one or more policies (e.g., security policies), etc.

The B-node 202 is intended to represent a B-node like the B-node 104 described with reference to FIG. 1. The S-nodes 204 are intended to represent S-nodes like the S-nodes 108 described with reference to FIG. 1. The services 206 are intended to represent services like the services 116 described with reference to FIG. 1.

The CXP 200 further comprises a distributed service stitching (DSS) engine 208 coupled to the S-nodes 204, a monitoring engine 210 coupled to the S-nodes 204, a provisioning engine 212 coupled to the S-nodes 204, an analytics engine 214 coupled to the S-nodes 204, a data ingestion engine 216 coupled to the S-nodes 204, a policy engine 218 coupled to the S-nodes 204, a multi-tenant orchestration (MTO) engine 220 coupled to the S-nodes 204, and a V-node 222 coupled to the S-nodes 204. Further, the V-Node 222 is intended to represent an engine that couples the CXP 200 to a VPC. The VPC may relate to Software as a service (SaaS), Infrastructure as a service (IaaS), Platform as a service (PaaS), or virtual network (V-net). In an example, the V-node 222 may enable cloud-to-cloud traffic. For example, the V-node 222 (potentially including other V-nodes, not shown) connects the CXP 200 to different clouds.

The DSS engine 208, the monitoring engine 210, the provisioning engine 212, the analytics engine 214, the data ingestion engine 216, the policy engine 218, the MTO engine 220, and the S-nodes 204 may collectively form and may be referred to as a cloud services node (CSN) 224.

The DSS engine 208 may be configured to stitch together (i.e. provide coherent communication, coordination, and connection to) one or more S-nodes associated with a plurality of CXPs associated with a respective plurality of different regions. In an example, the DSS engine 208 is configured to enable services from other regions (other CXPs) to be properly hosted in a region with which the S-nodes 204 are associated in order to satisfy one or more restrictions or regulations of a service/application. The DSS engine 208 may operate to establish a mesh network, a hub and spoke network, or any other applicable network distribution paradigm, or a combination of these between the CXPs of different regions by connecting corresponding S-nodes.

The monitoring engine 210 may be configured to inspect data packets passed to the S-nodes 204 and identify attributes about individual packets or groups of packets. Examples of the attributes of a data packet may include, but is not limited to, header information that may be used to identify a source, destination, or application/service relevant to the data packet.

The provisioning engine 212 may be configured to facilitate provisioning of one or more of the services 206 responsive to a request therefor. In certain cases, the S-nodes 204 are configured to host the requested service itself, enabling the customer to access the service through its connection to the S-nodes 204, without having to establish connectivity with the service provider or having to be connected to a service provider's platform.

The analytics engine 214 may be configured to obtain data from data ingestion engine 216 (which is configured to receive data from network elements and/or endpoints, and collect telemetry) and provide data analytics corresponding to, for example, traffic coming into the S-nodes 204, corresponding services 206 being used in connection with the S-nodes 204 throughout a connected network, connectivity issues within a network, and the like. Further, the policy engine 218 is configured to apply the policy 110 at the S-nodes 204. For example, the policy 110 is identifiable from a user request for the policy to be applied to a given flow of traffic. In an example, the policy 110 may be applied without requiring the customer to instantiate a service that applies the policy 110.

The MTO engine 220 is configured to automatically instantiates one or more of the services 206, which may be available across a series of CSNs, to multiple tenants without requiring manual instantiation by the tenants. The one or more services may be selected by the tenants for instantiations. In an example, the MTO engine 220 is SaaS-based. In certain cases, orchestration features provided by the MTO engine 220 may be provided as a wrapper around a third-party service, such as where the MTO engine 220 is integrated directly within a third-party service, in a transparent or apparent manner. In such cases, only certain features of a particular service that are supported by the CSN 224 may be shown. To this end, the orchestration provided by the MTO engine 220 may be offered as a distinct SaaS in addition to other third-party services.

In an example, the CSN 224 may include a collection of engines associated with the S-nodes 204. In another example, the CSN 224 may be incorporated within the one or more S-nodes 204. In yet another example, the services 206 are also incorporated within the CSN 224 (or one or more S-nodes).

The V-node 222 is intended to represent a V-node like the V-node 110 described with reference to FIG. 1.

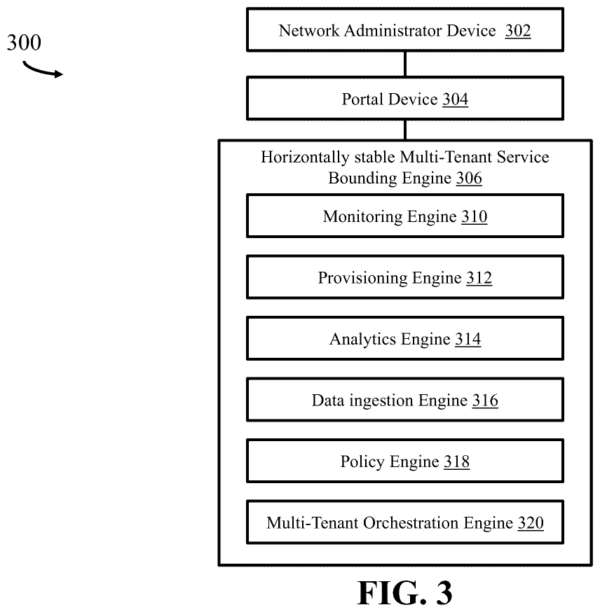

FIG. 3 is a diagram 300 of an example of a plurality of regional services exchange points (RSXP) stitched together to form a network. The diagram 300 includes an RSXP 302-1 to an RSXP 302-n (collectively, the RSXPs 302). The RSXP 302-1 includes a DSS engine 304-1, the RSXP 302-2 includes a DSS engine 304-2, and the RSXP 302-n includes a DSS engine 304-n. The DSS engines 304-1 to 304-n can collectively be referred to as DSS engines 304. The RSXP 302-1 includes a service 306a, the RSXP 302-2 includes a service 306b, and the RSXP 302-n includes a service 306n. The services 306a to 306n can collectively be referred to as services 306. It may be noted that the services 306 are depicted as coupled to the DSS engines 304 for conceptual purposes, but it should be understood the services could be coupled to S-nodes as depicted in FIG. 2. In an example, the network may be cloud network within which a software application may be hosted.

The RSXPs 302 are intended to represent engines, at least including the DSS engines 304, associated with different geographic, geopolitical, national, or other regions. The DSS engines 304 act as single engine with respect to each of the services 306 regardless of the region in which the services 306 are found.

FIG. 3 is a diagram 300 of an example of a horizontally scalable multi-tenant service bounding engine. The diagram 300 includes a network administrator device 302, a portal device 304, and a horizontally scalable multi-tenant service bounding engine 306. The horizontally scalable multi-tenant service bounding engine 306 includes a monitoring engine 310, a provisioning engine 312, an analytics engine 314, a data ingestion engine 316, a policy engine 318, and a multi-tenant orchestration engine 320, which are similar in function to the monitoring engine 210, the provisioning engine 212, the analytics engine 214, the data ingestion engine 216, the policy engine 218, and the multi-tenant orchestration engine 220 of FIG. 2.

The network administrator device 302 is intended to represent an end user device utilized by a network administrator of a customer, or a human or artificial agent thereof. In a specific implementation, the network administrator device 302 is a smartphone, tablet device, laptop, or other personal computing device of a network administrator, or a human or artificial agent thereof.

The portal device 304 is intended to represent a network device through which a network administrator, or agent thereof, can utilize the network administrator device 302 to access the horizontally scalable multi-tenant service bounding engine 306. In a specific implementation, the network administrator, or agent thereof, accesses features and functionality of the horizontally scalable multi-tenant service bounding engine 306 via the portal device 304, through which they may make selections.

The horizontally scalable multi-tenant service bounding engine 306 may be implemented within a CXP, such as the CXP 114 or FIG. 1, an S-node, such as one or more of the S-nodes 108 of FIG. 1 or the S-nodes 204 of FIG. 2, or a CSN, such as the CSN 224 of FIG. 2. Advantageously, and as the name suggests, the horizontally scalable multi-tenant service bounding engine 306 facilitates horizontal scaling for multi-tenant service.

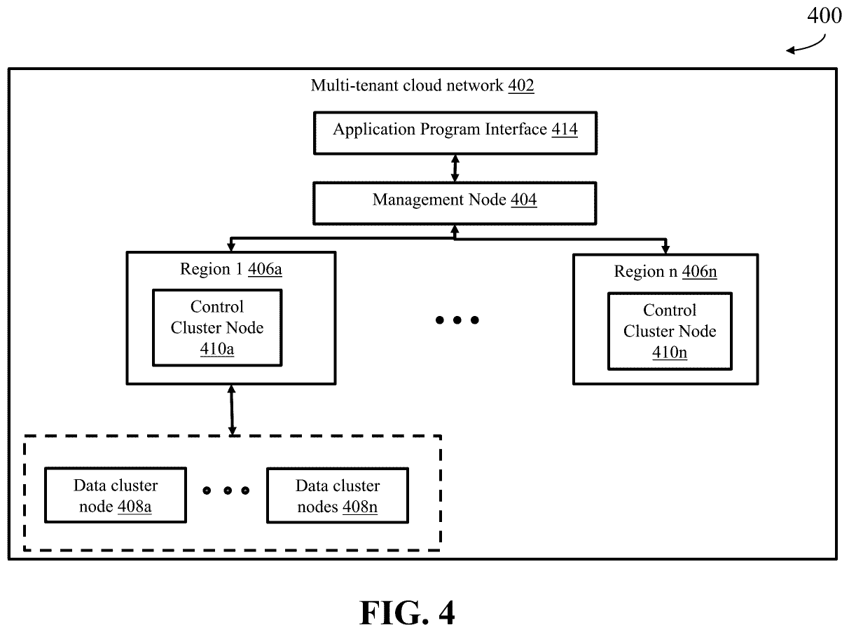

FIG. 4 illustrates an example block diagram 400 for multitenant cloud network 402, according to an embodiment of the present disclosure.

The multi-tenant cloud network 402 is a cloud infrastructure that may include one or more hardware and software components, such as servers, storage, networking, virtualization software, services and management tools, that support the computing requirements of a cloud computing model. The multi-tenant cloud network 402 may further include an abstraction layer that virtualizes and logically presents resources and services to users through application programming interfaces (API) 414 and API-enabled command-line or graphical interfaces.

In some embodiments, the multi-tenant cloud network 402 may support cloud computing by disaggregating functions and features of the one or more hardware and software components. Further, the multi-tenant cloud network 402 in the case of private cloud may host virtualized resources and delivers them to users over the internet or a network. Such resources may support extensive and task-specific services, such as communication, book-keeping, statistics, processing, etc.

Moreover, types of the multi-tenant cloud network 402 may also include a user interface (UI) for managing these virtual resources. For example, the multi-tenant cloud network 402 may also include Infrastructure as a Service (IaaS). With the IaaS, a team or enterprise acquires the computing infrastructure it needs over the Internet, including computing power (such as on physical or virtual machines), storage, and a plurality of related needs such as load balancers and firewalls.

The multitenant cloud network 402 is a virtualized computing infrastructure that allows multiple tenants to share the same physical resources, such as storage devices, servers, and networking equipment. The multitenant cloud network 402 may comprises a management node 404, one or more control cluster nodes (depicted as control cluster nodes 410a to 410n, and collectively referred to as control cluster nodes 410) for one or more regions (depicted as regions 406a to 406n, and collectively referred to as regions 406), and a plurality of data cluster nodes (depicted as data cluster nodes 408a to 408n, and collectively referred to as data cluster nodes 408). For example, a plurality of data cluster nodes may be associated with each of the regions 406 and corresponding control cluster nodes 410.

The data cluster nodes 408 may form a data plane. In an example, an architecture of the data plane may include worker nodes with pods and nodes or containers communicating via certain agents (such as, kubelet agents), that may be configured to share states and conditions with a container engine and a database that maintains state information. Each of the worker nodes may receive configuration instructions from a corresponding control cluster node from the control cluster nodes 410 forming a control plane. The worker nodes may receive specification and configuration information from an API server. Each worker node may have a proxy (such as a kube-proxy). The proxy may manage network communication among the pods and from the other nodes. In an embodiment, the worker nodes, along with certain inherent components, may carry out the configuration established by the control plane.

In an example, the data cluster nodes 408 are configured to carry user traffic data associated with tenant nodes across different connecting endpoints of tenant architecture associated with the tenant nodes. For example, certain data cluster nodes 408 may relate to a tenant network and any traffic data coming from a tenant node of the tenant network may be carried across its end points to facilitate data transfer, communication, etc.

In an example, in a software defined networking (SDN) and network functions virtualization (NFV), the data plane may be implemented in a software application (such as a software-as-a-service). The data plane may form a network configuration that may configure a pod to communicate with other pods. The pod may be assigned to a unique IP address for a communication between the pod with other pods and the data cluster nodes 408. The pod may contain one or more containers of resources. The pod may further be connected to one or more data cluster nodes 408 to transfer data packets. The data plane may transfer the data between the data cluster nodes 408 in a network using a combination of routing, switching, and forwarding techniques. The data cluster nodes 408 may connect each other through a physical or logical links. To transfer a data packet from one node (e.g. node 408a) to another node (e.g. node 408n), the data packet may be encapsulated with the necessary protocol headers, such as IP and TCP headers, and then forwarded from source node (e.g. 408a) to the designation node (408n).

Further, the control cluster nodes 410 may formed a control plane for controlling policies and operations of respective data cluster nodes 408, based on corresponding regions 406. The control cluster nodes 410 may form clusters or micro-clusters that may be configured to manage one or more worker nodes and pods in a data plane, such as the data cluster nodes 408. In certain cases, the control cluster nodes 410 may run across multiple computers and a cluster usually runs or governs multiple nodes. In an example, the control cluster nodes 410 are configured to provision a set of rules for the data cluster nodes 408 based on corresponding regions 406.

In some embodiments, the control plane of the control cluster nodes 410 may be a part of a Containers as a service (CaaS) cluster. The control cluster nodes 410 may manage and control every component of the CaaS cluster. The control cluster nodes 410 may be further configured to handle one or more operations in the CaaS cluster. Furthermore, components of the control cluster nodes 410 may define and control configuration and state data of the CaaS clusters. The control cluster nodes 410 may configure and run deployment, management, and maintenance of containerized applications in the CaaS cluster. The control cluster nodes 410 may have one or more components, such as an application programming interface (API), a scheduler, a controller manager, a key-value database and a cloud control manager.

The cloud-controller-manager runs only controller's specific to the cloud provider. It is not required for on-premises Kubernetes environments. It uses multiple, yet logically-independent, control loops that are combined into one binary, which can run as a single process. It can be used to add scale a cluster by adding more data cluster nodes on cloud VMs, and leverage cloud provider high availability and load balancing capabilities to improve resilience and performance.

Further, the management node 404 may include to a cluster that may be configured to run one or more appliances, such as the data cluster nodes 408, and the one or more appliances may be administered from any of the control cluster nodes 410. In some embodiments, the management node 404 may be connected to client systems that direct web traffic to it for filtering purposes. Further, the management node 404 may be assigned to node groups. The node groups may enable common administration activities for node group members, for example, transferring data for updates from one node to another node or several other nodes. The management node 404 may be configured to manage an overall network infrastructure, including the data plane and the control plane. It provides the tools and mechanism to monitor and configure network devices and services, and to ensure that the multi-tenant cloud network 402 is operating as intended. For example, the management node 404 is configured to enable management of at least one of: a tenant node, a network configuration of the multi-tenant cloud network 402, infrastructure resources of the multi-tenant cloud network 402, and a software application inventory relating to a software application provided by the multi-tenant cloud network 402. In an example, the tenant nodes 710 may access the software application 704 associated with the multi-tenant cloud network 402 using the management node 404.

Typically, the management node 404 may form a central management cluster that may be a member of a runtime group and may share runtime data with all other nodes in the group. The runtime data may refer to data that may be created at runtime on an appliance. For example, an amount of time that may be left for a user at a given point in time when a quota restriction has been imposed on web usage is the runtime data. For example, the management node 404 may be a member of one particular runtime group at a time.

Furthermore, the management node 404 may be a member of an update group that may be configured to share updates with all other nodes in the group. For example, the management node 404 may be a member of one particular update group at a time.

Moreover, the management node 404 may be a member of a network group that may be configured to immediately connect to all other nodes in the group. For example, the management node 404 may be a member of different network groups at a time. In an embodiment, communication between the nodes in the multi-tenant cloud network 402 may be usually Secure Sockets Layer (SSL)-secured.

In an example, the multi-tenant cloud network 402 may be a multiple users (such as customers or tenants) using shared computing resources. Typically, a multi-tenant architecture may be configured to serve multiple users, such as customers or tenants using a single instance of software running on a server. In an embodiment, separate users in the multi-tenant environment tap into a same data storage and hardware, each creating a dedicated instance. Although every tenant's data runs on the same server, it may remain isolated and invisible to other tenants. Each tenant may have different requirements based on needs such as security protocols, compliance requirements and budget allocations. A multi-tenant load balancer may manage the requirements for each of the tenants within a same central management cluster.

In accordance with an embodiment, in a multi-tenant environment of the multi-tenant cloud network 402, a tenant is an entity that can be represented by, or otherwise associated with, one or more partitions and/or one or more tenant-aware applications. For example, tenants can represent distinct user organizations, such as different external companies, or different departments within a particular enterprise (e.g., HR and Finance departments), each of which can be associated with a different partition. A tenant globally unique identity (tenant ID) may be the association of a particular user, at a particular moment in time, with a particular tenant. The multi-tenant load balancer may derive which tenant a particular user belongs to from the user identity, for example by referring to a user identity store. The user identity enables the multi-tenant cloud network 402 to enforce those actions that a user is authorized to perform, including, but not limited to, a tenant to which the user may belong.

In accordance with an embodiment, the multi-tenant load balancer enables isolation of the administration and runtime of different tenants from each other. For example, tenants can configure some behaviors of their applications, and resources to which they have access. The system can ensure that a particular tenant cannot administer artifacts belonging to another tenant; and, at runtime, that the applications working on behalf of a particular tenant refer only to resources associated with that tenant, and not to resources associated with other tenants.

In accordance with an embodiment, a tenant-unaware application is one that contains no logic dealing with tenants explicitly, such that any resources that the multi-tenant cloud network 402 provides may be accessible to all users of all tenants regardless of which user submitted a request. In contrast, a tenant-aware application includes logic that explicitly deals with different tenants and their corresponding users differently. For example, based on a user's identity the multi-tenant cloud network 402 can derive a tenant to which a user belongs and use that information to access and provide tenant-specific resources.

In accordance with an embodiment, the multi-tenant cloud network 402 enables users to deploy software applications that are explicitly written to be tenant-aware, so that application developers may obtain the tenant ID of a current tenant. The tenant-aware software application may then use the tenant ID to handle multiple tenants that are using a single instance of the software application.

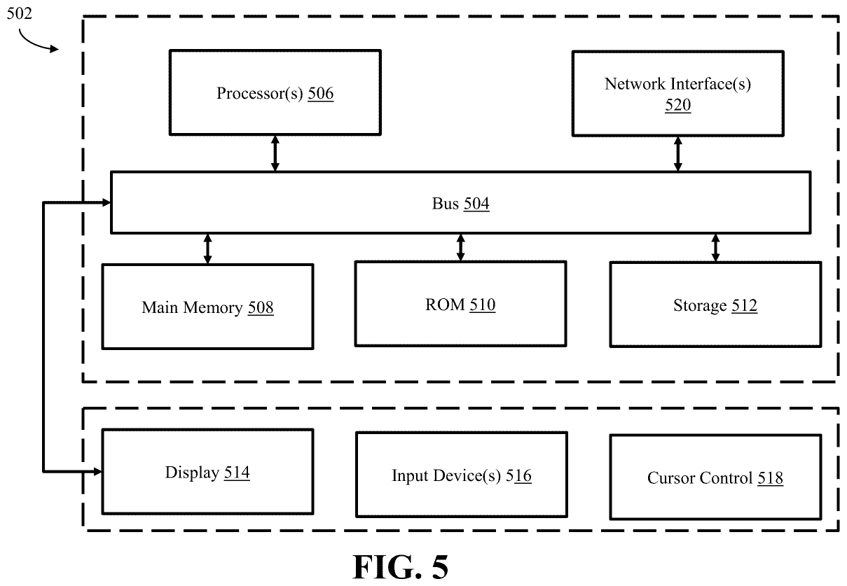

FIG. 5 is a diagram of an example of a computer system 502. The computer system 502 includes a bus 504 or other communication mechanism for communicating information, one or more hardware processors (referred to as the processor) 506 coupled with the bus 504 for processing information, and a main memory (referred to as the memory) 508 coupled to the bus 504 for storing information and instructions to be executed by the processor 506. The memory 508 may also be used for storing temporary variables or other intermediate information during execution of instructions to be executed by the processor 506. Such instructions, when stored in storage media accessible to the processor 506, render the computer system into a special-purpose machine configured to perform the operations specified in the instructions. Such instructions may be read into the memory 508 from another storage medium, such as the storage device 512. Execution of the sequences of instructions contained in the memory 508 causes the processor 506 to perform process steps, such as those described in the present disclosure, to act as a specially purposed machine.

The computer system 502 further includes, coupled to the bus 504, a read only memory (ROM) 510 or other static storage device, such as a magnetic disk, optical disk, or USB thumb drive (Flash drive), for storing static information and instructions for the processor 506, a display 514, such as a liquid crystal display (LCD) (or touch screen) for displaying information to a computer user, an input device 516, such as a keyboard including alphanumeric and other keys for communicating information and command selections to the processor 506, and a cursor control device 518, such as a mouse, a trackball, cursor direction keys, or other type of input device for communicating information and/or command selections to the processor 506 and for controlling cursor movement on the display 514. Instead or in addition, the same information and command selections as cursor control may be implemented via receiving touches on a touch screen (e.g., of the display 514 or some other device with a screen).

The computing system 502 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component” may refer to logic embodied in hardware or firmware, or to a collection of software instructions, possibly having entry and exit points, written in a programming language, such as, for example, Java, C or C++. An engine may include hardware or firmware. The term “engine,” is not intended to represent a “software engine.” A software component may be compiled and linked into an executable program, installed in a dynamic link library, or may be written in an interpreted programming language such as, for example, BASIC, Perl, or Python. It may be noted that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as the storage device 512. Volatile media includes dynamic memory, such as the memory 508. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus 504. Transmission media can also take the form of acoustic or light waves, such as those generated during radio-wave and infra-red data communications.

The computer system 502 may also include one or more network interfaces (referred to as the communication interface) 520 coupled to the bus 504. The communication interface 520 provides a two-way data communication coupling to one or more network links that are connected to one or more local networks. For example, the communication interface 520 may be an integrated services digital network (ISDN) card, cable modem, satellite modem, or a modem to provide a data communication connection to a corresponding type of telephone line. In another example, the communication interface 520 may be a local area network (LAN) card to provide a data communication connection to a compatible LAN (or WAN component to communicated with a WAN). Wireless links may also be implemented. In such an implementation, the communication interface 520 sends and receives electrical, electromagnetic or optical signals that carry data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface 520, which carry the digital data to and from the computer system, are example forms of transmission media.

In operation, the computer system 502 may send messages and receive data, including program code, through the network(s), network link, and the communication interface 520. In an example, a server might transmit a requested code for an application program through the Internet, the ISP, the local network and the communication interface 520. The received code may be executed by the processor 506 as it is received, and/or stored in the storage device 512, or other non-volatile storage for later execution or playback.

Each of the processes, methods, and algorithms described in the present disclosure may be embodied in, and fully or partially automated by, code components executed by the computer system 502 or computer processors comprising computer hardware. The computer system 502 or computer processors may also operate to support performance of the relevant operations in a “cloud computing” environment or as a SaaS. The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

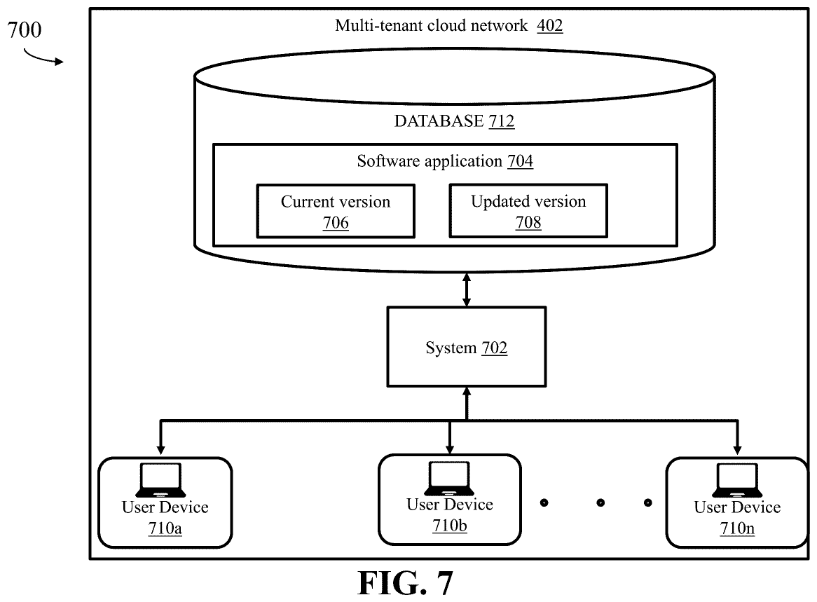

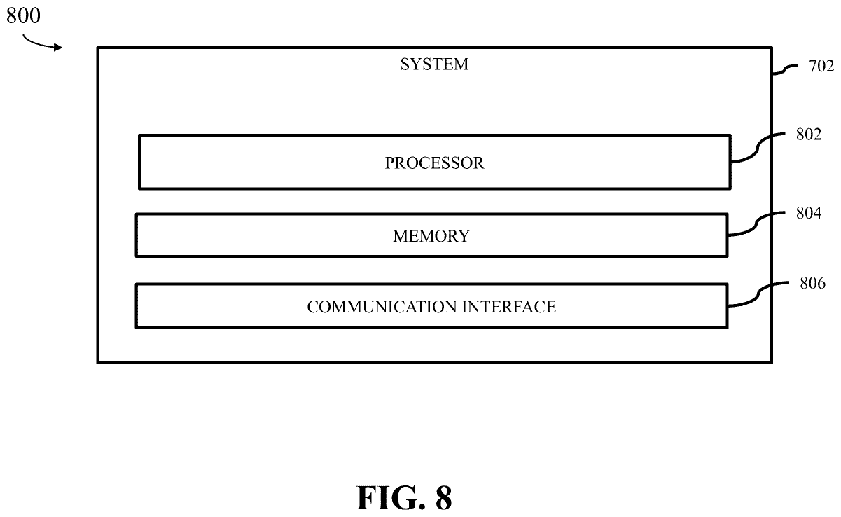

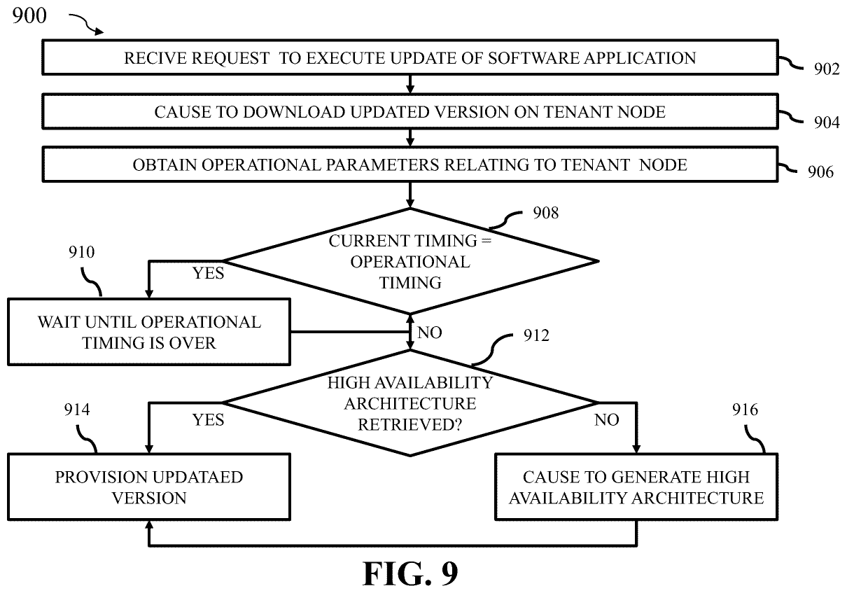

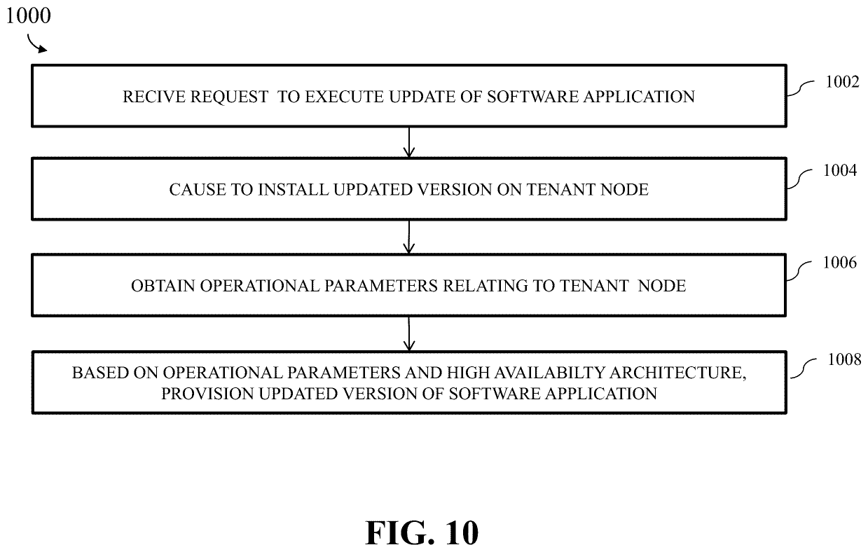

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto. A manner in which the computing system 502 operates to update a software application in the multi-tenant cloud network 402 is described in detail in conjunction with FIG. 7, FIG. 8, FIG. 9 and FIG. 10.

In an example, a tenant node may be implemented as a computing system, such as the computer system 502. In such a case, the software application hosted by software-as-a-service-based multi-tenant cloud network 402 may be running on the tenant node. The tenant node may connect to the SaaS software application and/or the multi-tenant cloud network 402 through a network connection, such as via the communication interface 520. For example, the connection between the tenant node and the multi-tenant cloud network 402 is based on standard internet protocols and technologies, such as HTTP, TCP/IP, and SSL/TSL.

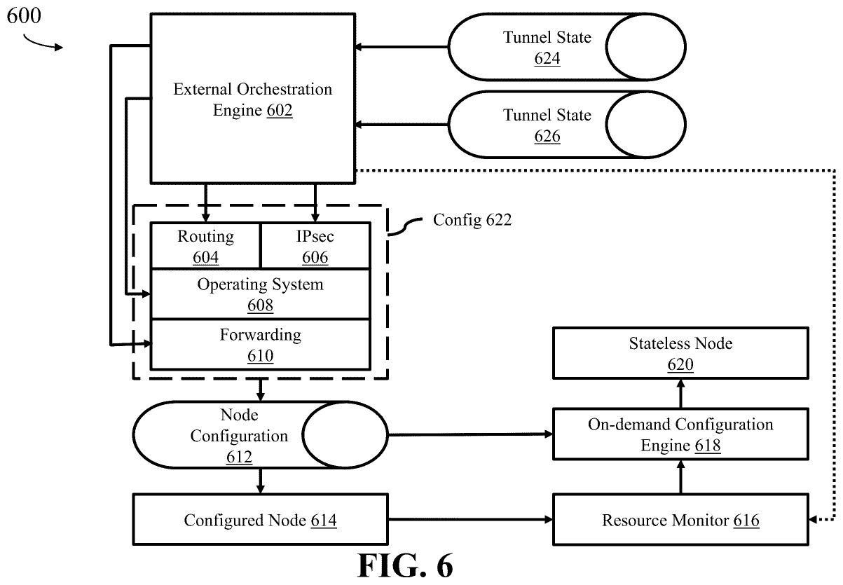

FIG. 6 is a diagram 600 of an example tenant node configuration, in accordance with an example. The diagram 600 includes an external orchestration engine 602, a routing component 604 coupled to the external orchestration engine 602, an IPsec component 606 coupled to the external orchestration engine 602, an operating system (OS) component 608 coupled to the external orchestration engine 602, and a forwarding component 610 coupled to the external orchestration engine 602. The routing component 604, the IPsec component 606, the OS component 608, and the forwarding component 610 can be collectively referred to as a configuration data structure 622.

The diagram 600 further includes a node configuration data store 612 coupled to the configuration data structure 622, which represents a communication medium from the external orchestration engine 602 over which the configuration data structure is provided for storage in the node configuration data store 612, a configured node 614 coupled to the node configuration data store 614, a resource monitor 616 coupled to the configured node 614, an on-demand configuration engine 618 coupled to the resource monitor 616 and the node configuration data store 612, a stateless node 620 coupled to the on-demand configuration engine 618, a tunnel state data store 624 coupled to the external orchestration engine 602, and a tenant state data store 626 coupled to the external orchestration engine 602.

The external orchestration engine 602 is intended to represent an engine that knows tunnel state (represented by the tunnel state data store 624), which tenant is on which node (represented by the tenant state data store 626), and how to configure nodes. The term “external” in this context is intended to mean node-external or router-external, as in the external orchestration engine 602 is implemented outside of a router. In a specific implementation, node configuration is performed outside of nodes of tenants. Advantageously, a node of a tenant can be ripped and replaced due to node configuration being stored outside of the node to be replaced. It may be noted that, with this implementation, it is not necessary for redundant nodes to synch with each other, which is beneficial because redundant nodes have a cost (e.g., synch modules); node-to-node synch communication is at least ameliorated and at best eliminated using the techniques described in the present disclosure.

The routing component 604 is intended to represent a software component implemented on a configured node, such as the configured node 614. Routing forms virtual routing and forwarding (VRF) context for a tenant.

The IPsec component 606 is intended to represent a software component implemented on a configured node, such as the configured node 614. IPsec is a secure network protocol suite that authenticates and encrypts the packets of data to provide secure encrypted communication between two computers over an Internet Protocol network. IPsec includes protocols for establishing mutual authentication between agents at the beginning of a session and negotiation of cryptographic keys to use during the session. In a specific implementation, the IPsec component 606 is compliant with strongSwan, a multiplatform IPsec implementation.

The OS component 608 is intended to represent a software component implemented on a configured node, such as the configured node 614. In a specific implementation, the OS component 608 is compliant with Linux.

The forwarding component 610 is intended to represent a software component implemented on a configured node, such as the configured node 614. Forwarding includes flow management enabling flow-based routing. In a specific implementation, the forwarding component 610 is compliant with vector packet processing (VPP), a software algorithm that is used to quickly process network packets.

The node configuration data store 612 is intended to represent a data store of configuration parameters for a node. In a specific implementation, the node configuration data store is an etcd data store, etcd is a strongly consistent, distributed key-value store that provides a reliable way to store data that needs to be accessed by a distributed system or cluster of machines. In a specific implementation, the provisioning of nodes is accomplished using an entity relationship diagram (ERD) tool.

The configured node 614 is intended to represent a B-node, such as the B-node 104 of FIG. 1, an S-node, such as one of the S-nodes 108 of FIG. 1, or a V-node, such as the V-node 110 of FIG. 1. In a specific implementation, within the configured node 614 are configuration parameters such as represented in the diagram 600 as config data structure 622 (i.e., the routing component 604, the IPsec component 606, the OS component 608, and the forwarding component 610). Although the configured node 614 is coupled to the node configuration data store 612 and, at least by implication, received configuration parameter values from the node configuration data store 612, it should be understood that, instead or in addition, the configured node 614 could be pre-configured (i.e., at least partially configured prior to being coupled to the node configuration data store 612).

The resource monitor 616 is intended to represent an engine that sends a trigger to the on-demand configuration engine 618 responsive to a stimulus from the configured node 614. Instead or in addition, the stimulus could come from some other source, such as the external orchestration engine 602, which is represented in the diagram 600 as a dotted arrow from the external orchestration engine 602 to the resource monitor 616. The stimulus is indicative of a need to spin up additional nodes to handle network resource consumption.

The on-demand configuration engine 618 is intended to represent an engine that provides node configuration parameter values to the stateless node 620 in response to a trigger from the resource monitor. In a specific implementation, the trigger is an indication that additional nodes are needed to handle network resource consumption. If network resource consumption decreases, the stimulus from the configured node 614 to the resource monitor 616 could also trigger the on-demand configuration engine 618 to tear down nodes (not shown).

The stateless node 620 is intended to represent a node that is not initially employed to handle network resource demands (e.g., traffic). Upon obtaining configuration parameter values from the node configuration data store 612 via the on-demand configuration engine 618, where the configured node 614 is a first configured node, the stateless node 620 becomes a second configured node. In an alternative, the stateless node 620 could initially be handling network resource demands but its configuration is changed by the on-demand configuration engine 618 upon receipt of a trigger at the on-demand configuration engine 618 from the resource monitor 616.

FIG. 7 shows a network environment 700 in which a system 702 for updating a software application 704 in the multitenant cloud network 402 is implemented, according to an example embodiment. The system 702 for updating the software application 704 in the multitenant cloud network 402 is configured to update a current version 706 of the software application 704 on a user device. For example, the system 702 may update the software application 704 from the current version 706 to an updated version 708 on the user device. The software application 704 may be stored within a database 712 of the multi-tenant cloud network 402.

The database 712 may also include a number of service computer devices which may be divided into multiple computer sets. Each computer set may include one or more service computer devices. Each computer set may execute a different version of the software application 704, which may be a Software-as-a-Service (SaaS) software application. For example, the database 712 includes two computer sets executing two different versions of a software application. The two computer sets may execute the current version 706, and the updated version 708. The service computer devices of the database 712 may include multiple service computer devices connected in a network (e.g., a local area network or wireless local area network), or may include multiple service computer devices distributed throughout the Internet, or may include some combination thereof, and may include physical machines, virtual machines, or some combination thereof.

The software application 704 stored by the database 712 may be a Software-as-a-Service (SaaS) software application. This means that the software application may provide service(s) to the tenant nodes 710 on demand as requested by the tenant nodes 710. Such a request can then be interpreted by the system 702. In particular, such a request from a tenant nodes 710a can originate from a version of the software application 704 executing on the tenant node 710a. Such a request can alternately originate from one or more portal server(s), or pass through one or more portal server(s) after originating from the tenant node 710a. The one or more portal server(s) may include portal servers connected to the tenant nodes 710 through the public internet and/or may include portal servers within the same private network as the tenant nodes 710. The one or more portal server(s) may then host a network portal, which may be a public internet portal (e.g., a public website) or a private intranet portal (e.g., a private network portal).

In an example, the software application 704 may be a software provided as software-as-a-service. The software application 704 may be a type of computer program that performs a specific personal, educational, and business function. The software application 704 may be designed to assist end-users in accomplishing a variety of tasks, which may be related to productivity, creativity, or communication. For example, the software application 704 may include a plurality of processes; each process can have a sequence of Graphical User Interface (GUI) windows, objects and data elements. During the development of the software application 704, as well as while after deployment of the software application 704, the software application 704 may continually need to be advanced, and updated. In certain cases, the software application 704 may be updated by adding more features for access and use by user. Typical examples of these software applications may include operating systems, application servers, and other complex software applications.

The current version 706 may refer to a version of the software application 704 that is relatively up-to-date and modern (though typically is not the newest available version) and is extensively tested. The current version 706 typically work with most modern software and hardware innovations, have most known security vulnerabilities patched, have most known bugs fixed. “Current” software versions of SaaS software may be useful to use with “production” systems or systems that are relied upon by customers of the SaaS service to support the customer's own products (which in turn may be relied upon by the customer's own customers).

The updated version 708 of the software application 704 may be, for example, used to refer a very new version of the software application 704 that is very up-to-date and modern, but has not yet had a chance to be as extensively tested as the current version 706. The updated version 708 may work with most modern software and hardware innovations, sometimes even more so or better than the current version 706, may have many known security vulnerabilities patched (sometimes more than the current version 706), and may have many known bugs fixed (sometimes more than the current version 706). The updated version 708 of the software application 704 may be useful for customer business/organization when the customer business/organization is trying to develop its own updated product, particularly if the updated product is to make use of new features (e.g., new functions of the service) that are new to the updated version 708 of the software application 704. To this end, the updated version 708 of the software application 704 comprises one or more new feature functionalities and/or bug fix or security patches over the current version 706.

While the tenant node 710a, the tenant node 710b, and tenant node 710n are all illustrated as laptop computers, each of these tenant nodes 710, or any other device connected to the multi-tenant cloud network 402, may be any type of computer device, such as a laptop computer, a desktop computer, a smart television, a home entertainment system, a video game console, a smartphone device, a tablet device, a portable media player device, or a wearable device.

The network environment 700 may include tenant nodes, depicted as tenant nodes 710a, 710b, . . . , 710n (collectively referred to as tenant nodes 710). The tenant nodes 710 may be a computer system on which the software application 704 may run that is hosted by a software-as-a-service provider or the multi-tenant cloud network 402. For example, each of the tenant nodes 710 may be associated with a single version of the software application 704, though not all of the tenant nodes 710 may be associated with a same version of the software application 704. To this end, the versions on the tenant nodes 710 may be current version 706 or other older versions of the software application 704. Such older versions or the current version 706 may have to be updated to enable users associated with the tenant nodes to use the new features or enhanced version of the software application 704.

In order to enable updating of a version of the software application 704 running on the tenant nodes 710, embodiments of the present disclosure discloses the system 702 for updating the software application 704 in the multi-tenant cloud network 402. Details of operations of the system 102 are described in conjunction with, for example, FIG. 8.

FIG. 8 shows a block diagram 800 of the system 702 for updating the software application 704 in the multi-tenant cloud network 402, according to an example embodiment. The system 702 may include one or more processors 802 (referred to as processor 802, hereinafter), a memory 804 and a communication interface 806.

The processor 802 may be embodied in a number of different ways. The memory 804 may be non-transitory and may include, for example, one or more volatile and/or non-volatile memories.

In accordance with an embodiment, the system 702 may store data that may be generated by the processor 802 while performing corresponding operation or data that may be retrieved from a database associated with the system 802, such as a third-party database, etc. within the memory 804.

The processor 802 is coupled to the memory 804 and the I/O interface 806. The memory 804 may have stored therein at least one of the programs or instructions executed by the processor 802 to configure the system 702 to perform the operation relating to updating of the software application 704. The processor 802 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 802 may include one or more processing cores configured to perform independently. A multi-core processor may enable multiprocessing within a single physical package. Additionally or alternatively, the processor 802 may include one or more processors configured in tandem via the bus to enable independent execution of instructions, pipelining and/or multithreading. Additionally or alternatively, the processor 802 may include one or more processors capable of processing large volumes of workloads and operations to provide support for big data analysis. In an example embodiment, the processor 802 may be in communication with the memory 804 and/or the I/O interface 806 via a bus for passing information among components of the system 702.

In an example, when the processor 802 is embodied as an executor of software instructions, the instructions may specifically configure the processor 802 to perform the algorithms and/or operations described herein when the instructions are executed. However, in some cases, the processor 802 may be a processor specific device (for example, a mobile terminal or a fixed computing device) configured to employ an embodiment of the present disclosure by further configuration of the processor 802 by instructions for performing the algorithms and/or operations described herein. The processor 802 may include, among other things, a clock, an arithmetic logic unit (ALU) and logic gates configured to support operation of the processor 802.

For example, the memory 804 may be an electronic storage device (for example, a computer readable storage medium) comprising gates configured to store data (for example, bits) that may be retrievable by a machine (for example, a computing device or the processor 802). The memory 804 may be configured to store information, data, content, applications, instructions, or the like, for enabling the system 702 to carry out various functions in accordance with an example embodiment of the present disclosure. For example, the memory 804 may be configured to buffer input data for processing by the processor 802. The memory 804 may be configured to store instructions for execution by the processor 802.

The memory 804 of the system 702 may be configured to store a dataset. In accordance with an embodiment, the memory 804 may include processing instructions for processing software application data.

In an example, a network environment, such as, 700 may be accessed using the communication interface 806 of the system 702. The communication interface 806 may provide an interface for accessing various features and data stored in the system 702 and nodes or entities external to the system 702.

In operation, the system 702 is configured to receive a request to execute an update of the software application 704 on a tenant node, say the tenant node 710a. In an example, the processor 802 may receive the request for update. In an example, a user associated with the tenant node 710a may raise and/or send the request for upgrading a version of the software application 704 on the tenant node 710 over the internet. In another example, the request may be received from the current version 706 currently running on the tenant node or may be initiated by the multi-tenant cloud network 402, for example, the management node 404. The update is performed for a conversion of the software application 704 from the current version 706 to the updated version 708.

Further, responsive to receiving the request, the system 702 may cause the tenant node 710a to install the updated version 708 on the tenant node 710a. The updated version 708 may relate to a micro-service of the software application 704. For example, the micro-service that is affected or updated by the updated version 708 is defined in version information relating to the updated version 708. For example, the system 702 or the processor 802 may cause the tenant node 710a to install or download the updated version 708 from the database 712 associated with the software application 704. In an example, the database 712 may be centralized. In another example, the database 712 may be distributed.

For example, the updated version 708 may include latest fixes and security improvements, helping the tenant node 710a to run efficiently and stay protected.

Further, the system 702 or the processor 802 may be configured to obtain operational parameters relating to the tenant node 710a. For example, the operational parameters may include, but is not limited to operation timing and operational traffic data. For example, the operational timing may indicate a preferred time of use of the software application on the tenant node 710a, or a usual time range during which the tenant node 710a is active. Moreover, the operational traffic data may include traffic cache of the software application 704 when the user of the tenant node is using the tenant node 710a. In an example, the operational traffic may also include certain user parameters, such as name, picture, profile data, profile settings, recent activities, etc.

Thereafter, based on the operational parameters and a high availability architecture relating to the software application 704, the system 702 or the processor 802 may be configured to provision the updated version 708 of the software application 704 on the tenant node 710. In particular, during the provisioning or installation of the updated version 708 of the software application 704 on the tenant node 710a, the tenant node 710a may continue to execute instances of the software application 704. For example, the high availability architecture of the software application 704 may include redundant hardware and/or data pertinent to the software application 704 and the tenant node 710a. Subsequently, operation of the software application 704 remain unaffected on the tenant node 710a during the provisioning of the software application 704, as the tenant node 710 may continue to execute functionalities or micro-services of the current version based on data of the operational parameters and the data stored in the high availability architecture.

In an example, during the provisioning of the updated version 708, the micro-service associated with the updated version 708 may be affected, down or interrupted. However, using the current version 706 and high availability architecture of the software application 704 and operational parameters of the tenant node 710a, micro-services other than the micro-service associated with the updated version 708 may continue to be executed using the current version 706 of the software application 704.

FIG. 9 illustrates an example flowchart of a method 900 for updating the software application 704 on the tenant node 710a, according to an example embodiment. The embodiments of FIG. 9 are explained in conjunction with FIG. 1, FIG. 2, FIG. 3, FIG. 4, FIG. 5, FIG. 6, FIG. 7, and FIG. 8.

In this regard, at 902, the system 702 may be configured to receive the request to execute the update of the software application 704. A tenant or the tenant node 710a may send the request using the software application 704 to the system 702 to execute a download and an installation of the updated version 708 of the software application 704 on the tenant node 710a.

The tenant node 710a may be a desktop or laptop computer, a smart phone, a PDA, and the like. In one embodiment, the tenant node 710a may be a part of the multi-tenant cloud network 402. For example, the request may indicate a tenant ID and a trigger for conversion of the current version 706 to the updated version 708. The user may request the system 702 for updating the software application 704 due to, for example, security flaws, less usability and less reliability, etc.

At 904, the system 702 may be configured to cause to install the updated version 708 on the tenant node 710a. The system 702 may cause the download of the updated version 706 on the tenant node 710, over the Internet. The updated version 708 may relate to a micro-service of the software application 704. In particular, the updated version may provide new feature or functionality relating to a micro-service provided by the software application 704. The micro-service may be a small independent service that rune a unique process to perform operations and/or generate output relating to the micro-service. It may be understood that the software application 704 may provide a plurality of micro-services. Examples of the micro-service provided by the software application 704 may include, but is not limited to, security, calling, messaging, data processing, user interface, compatibility with hardware, alerts and notification, user authentication, user identification, querying and search, payments, etc.

In certain cases, the system 702 and/or the multi-tenant cloud network 702 may be configured to deploy a continuous integration and continuous deployment (CI/CD) pipeline to enable automated identification of a problem associated with the micro-service of the software application. In an example, the CI/CD pipeline may automate building, testing, and deployment of different micro-services. For example, the CI/CD pipeline may also automate monitoring of a use of a micro-service to assess possible problems and possible solutions corresponding to the problems. Further, based on the identified possible problems, the CI/CD pipeline may cause the multi-tenant cloud network 402, for example, developers working within the multi-tenant cloud network 402, to generate the updated version 708 of the software application 708. The updated version 708 is configured to address the identified problem. In an example, CI/CD pipeline may ensure that new feature functionalities are delivered based on a roadmap of the software application 704 and the needs of the tenants.

At 906, operational parameters relating to the tenant node 710a are obtained. The system 702 may use these operational parameters to take a decision relating to the provisioning of the updated version 708 of the software application 704 on the tenant node 710a. The operational parameters may include, but not limited to, operational timing and traffic data. For example, the system 702 may obtain the operational parameters based on historical usage information of the tenant node 710a and/or the software application 704 on the tenant node 710a.

For example, operational timing may indicate information relating to the timing, when the tenant operates the tenant node 710a or when the tenant may use the software application 704. Further, the operational parameters may include the operational traffic data. The operational traffic data may include data packets being received or sent and/or scheduled to be received or sent on the tenant node 710a after the download of the updated version 708 of the software application 704.

Continuing further, at 908, a determination is made to check if a current time is same as the operational timing. For example, if the current time lies within the operational timing, then the system 702 may be configured to wait until the operational timing is ended. For example, the operational timing may indicate a time at which the tenant node 710a and/or the software application 704 on the tenant node 710a are executed. Subsequently, at 910, the system 702 may wait until the current time does not lie within the operational timing, i.e., the operational timing has ended or is yet to start. For example, operation timing for the tenant node 710a may be between 10 Am to 6 PM, then provisioning may be initiated before 10 AM or after 7 PM.

For example, the tenant associated with the tenant node 710a may be regularly active on the software application 704 during an operational timing between 10 AM to 6 PM. The system 702 is configured to obtain these operational timings of the tenant node 710a to identify an appropriate time to provision the updated version 708 on the tenant node 710a. Moreover, the updated version 710a may be provisioned on the tenant node 710a during non-operational timing to ensure the update of the software application 704 when the traffic data on the tenant node 710a is less or none to prevent any data loss.

Thereafter, when the current time does not lie within the operational timing, the method 900 may proceed to 912. At 912, a determination is made to check if a high availability architecture of the associated with the software application 704, or the tenant node 710a is retrieved or not. For example, the high availability architecture may be retrieved from a database associated with the software application 704 or the multi-tenant cloud network 402, such as the database 712. Alternatively, the high availability architecture may be generated by the system 702 based on data relating to the tenant node 710a and/or execution of the software application 704 on the tenant node 710a.

The high availability architecture may include at least information relating to the micro-service that is to be updated based on the updated version 708. In an example, the processor 802 may be configured to generate software data-based high availability architecture for the software application 704 and/or the tenant node 710a by replicating and storing the data of software application 704 associated with the tenant node 710a, for example, within a local storage of the tenant node 710a. This replicated data may include, for example, the information relating to the user interface of the software application 704, cache data, information relating to recent activities, information relating to scheduled activities, etc. Further, the replicated data may include the information relating to the tenant node 710a, such as IP address, information relating the user account hosting the tenant node 710a, tenant ID, and the like.

Further, if the high availability architecture is retrieved, the method 900 may proceed to 914. At 914, the updated version 708 of the software application 704 is provisioned on the tenant node 710a. During the provisioning of the updated version 708, micro-services other than a micro-service relating to the updated version 708 may remain unaffected, thereby ensuring continuous usage of the software application 704.

However, if the high availability architecture is not retrieved, at 916, the system 702 may further generate or cause to generate the high availability architecture to ensure redundancy and backup of the data relating to the tenant node 710a and the software application 704 to prevent any loss of stored data. On determining the high availability architecture generated for the software application 704, the software application 704 may be provisioned.

FIG. 10 illustrates an example flowchart of a method 1000 for updating the software application 704 in the multi-tenant cloud network 402, according to an example embodiment. The embodiments of FIG. 10 are explained in conjunction with FIG. 1, FIG. 2, FIG. 3, FIG. 4, FIG. 5, FIG. 6, FIG. 7, FIG. 8 and FIG. 9.

At 1002, a request to execute an update of the software application 704 is received. The tenant may raise the request with the system 702 using the tenant node 710a or the software application 704 to update the current version 706 of the software application 704 running on the tenant node 710a with the updated version 708.

At 1004, the updated version 708 may be downloaded on the tenant node 710a. The system 702 may cause to install the updated version 708 on the tenant node 710a. The updated version 708 may address a problem associated with a micro-service of the current version 706. In certain cases, the updated version 708 may address a plurality of problems associated with a same micro-service or different micro-services of the current version 706.

At 1006, operational parameters relating to the tenant node 710a are obtained. The operational parameters may be used to identify an appropriate time to provision the downloaded updated version 708 of the software application 704. These operational parameters may comprise the operational timing and the traffic data information.

At 1008, based on the operational parameters and a high availability architecture associated with the software application 704, the updated version 708 of the software application 704 may be provisioned on the tenant node 710a. By provisioning the updated version 708, the problem or the faulted micro-service of the current version 706 may be replaced without impacting other micro-services of the software application 704. The updated version 708 may be provisioned while the tenant node 710a is executing instances of the software application 704. For example, the instances of the software application 704 executing on the tenant node 710a relates to micro-services other than the micro-service of the updated version 708.

Accordingly, blocks of the method 1000 support combinations of means for performing the specified functions and combinations of operations for performing the specified functions for performing the specified functions. It will also be understood that one or more blocks of the method 1000, and combinations of blocks in the method 1000, can be implemented by special purpose hardware-based computer systems which perform the specified functions, or combinations of special purpose hardware and computer instructions.

Alternatively, the system 702 may comprise means for performing each of the operations described above. In this regard, according to an example embodiment, examples of means for performing operations may comprise, for example, the processor 802 and/or a device or circuit for executing instructions or executing an algorithm for processing information as described above.

On implementing the method 1000 disclosed herein, an end result generated by the system 702 is an updated software application; wherein such updating of a software application is used to improve user experience, enhance usability of the software application, remove downtime of the software application, etc.

Many modifications and other embodiments of the disclosures set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for updating a software application in a multi-tenant cloud network, comprising:
a memory configured to store computer executable instructions; and
one or more processors configured to execute the instructions to:
receive a request to execute an update of the software application on a tenant node associated with the multi-tenant cloud network, wherein the update is for a conversion of the software application from a current version to an updated version;
responsive to receiving the request, cause to install the updated version on the tenant node, the updated version relating to a micro-service of the software application;
obtain operational parameters relating to the tenant node, the operational parameters comprising at least operation timing and operational traffic data; and
based on the operational parameters and a high availability architecture relating to the software application, provision the updated version of the software application on the tenant node while the tenant node is executing instances of the software application during the provisioning of the updated version.

2. The system of claim 1, wherein the multi-tenant cloud network associated with the software application comprises:
a plurality of data cluster nodes configured to carry user traffic data associated with the tenant node across different connecting endpoints of a tenant architecture associated with the tenant node;
one or more control cluster nodes configured to provision a set of rules for the plurality of data cluster nodes based on a corresponding region; and
a management node configured to enable management of at least one of: the tenant node, network configuration, infrastructure resource, and software application inventory.

3. The system of claim 2, wherein the one or more processors are configured to execute the instructions to:
cause the tenant node to access the software application associated with the multi-tenant cloud network using the management node.

4. The system of claim 1, wherein the one or more processors are configured to execute the instructions to:
deploy a continuous integration and continuous deployment pipeline to enable automated identification of a problem associated with the micro-service of the software application; and
cause the multi-tenant cloud network to generate the updated version of the software application, wherein the updated version is configured to address the identified problem.

5. The system of claim 1, wherein the updated version of the software application comprises at least one of: one or more new feature functionalities, or bug fix over the current version.

6. The system of claim 1, wherein the instances of the software application executing on the tenant node relates to micro-services other than the micro-service of the updated version.

7. A method for updating a software application in a multi-tenant cloud network, comprising:
receiving a request to execute an update of the software application on a tenant node associated with the multi-tenant cloud network, wherein the update is for a conversion of the software application from a current version to an updated version;
responsive to receiving the request, causing to install the updated version on the tenant node, the updated version relating to a micro-service of the software application;
obtaining operational parameters relating to the tenant node, the operational parameters comprising at least operation timing and operational traffic data; and
based on the operational parameters and a high availability architecture relating to the software application, provisioning the updated version of the software application on the tenant node while the tenant node is executing instances of the software application during the provisioning of the updated version.

8. The method of claim 7 wherein the multi-tenant cloud network associated with the software application comprises:
a plurality of data cluster nodes configured to carry user traffic data associated with the tenant node across different connecting endpoints of a tenant architecture associated with the tenant node;
one or more control cluster nodes configured to provision a set of rules for the plurality of data cluster nodes based on a corresponding region; and
a management node configured to enable management of at least one of: the tenant node, network configuration, infrastructure resource, and software application inventory.

9. The method of claim 8, further comprising causing the tenant node to access the software application associated with the multi-tenant cloud network using the management node.

10. The method of claim 9, further comprising:
deploying a continuous integration and continuous deployment pipeline to enable automated identification of a problem associated with the micro-service of the software application; and
causing the multi-tenant cloud network to generate the updated version of the software application, wherein the updated version is configured to address the identified problem.

11. The method of claim 10, wherein the updated version of the software application comprises at least one of: one or more new feature functionalities, or bug fix over the current version.

12. The method of claim 8, wherein the instances of the software application executing on the tenant node relates to micro-services other than the micro-service of the updated version.

13. A non-transitory computer readable storage medium, having stored thereon, a set of computed-executable instructions that causes a computer to perform a method for updating a software application in a multi-tenant cloud network, comprising:
receiving a request to execute an update of the software application on a tenant node associated with the multi-tenant cloud network, wherein the update is for a conversion of the software application from a current version to an updated version;
responsive to receiving the request, causing to install the updated version on the tenant node, the updated version relating to a micro-service of the software application;
obtaining operational parameters relating to the tenant node, the operational parameters comprising at least operation timing and operational traffic data; and
based on the operational parameters and a high availability architecture relating to the software application, provisioning the updated version of the software application on the tenant node while the tenant node is executing instances of the software application during the provisioning of the updated version.

14. The non-transitory computer readable storage medium of claim 13, wherein the multi-tenant cloud network associated with the software application comprises:
a plurality of data cluster nodes configured to carry user traffic data associated with the tenant node across different connecting endpoints of a tenant architecture associated with the tenant node;
one or more control cluster nodes configured to provision a set of rules for the plurality of data cluster nodes based on a corresponding region; and
a management node configured to enable management of at least one of: the tenant node, network configuration, infrastructure resource, and software application inventory.

15. The non-transitory computer readable storage medium of claim 14, wherein the method comprises causing the tenant node to access the software application associated with the multi-tenant cloud network using the management node.

16. The non-transitory computer readable storage medium of claim 13, wherein the method comprises deploying a continuous integration and continuous deployment pipeline to enable automated identification of a problem associated with the micro-service of the software application; and causing the multi-tenant cloud network to generate the updated version of the software application, wherein the updated version is configured to address the identified problem.

17. The non-transitory computer readable storage medium of claim 13, wherein the updated version of the software application comprises at least one of: one or more new feature functionalities, or bug fix over the current version.

18. The non-transitory computer readable storage medium of claim 13, wherein the instances of the software application executing on the tenant node relates to micro-services other than the micro-service of the updated version.
